(19) United States
(12) Patent Application Publication
(10) Pub. No.: US 2014/0295243 A1
(43) Pub. Date: Oct. 2, 2014

(54) CONNECTOR FOR PRODUCING AN ELECTRICALLY CONDUCTIVE CONNECTION BETWEEN AT LEAST THREE TERMINALS OF BATTERY CELLS

(71) Applicant: Alexander Reitzle, Neu-Ulm (DE)

(72) Inventor: Alexander Reitzle, Neu-Ulm (DE)

(73) Assignees: SB Limotive Germany GMBH, Stuttgart (DE); SB Limotive Company LTD., Gyeonggi-do (KR)

(21) Appl. No.: 14/003,019

(22) PCT Filed: Feb. 28, 2012
(86) PCT No.: PCT/EP12/53314

§ 371 Date: Nov. 9, 2013

(30) Foreign Application Priority Data
Mar. 8, 2011 (DE) 102011005222.4

(51) Int. Cl. H01M 2/20; H01M 10/30; H01M 10/0525

(52) U.S. Cl. CPC H01M 2/206; H01M 10/0525; H01M 10/30; H01M 2220/20
USPC 429/121; 439/627; 429/158

(57) ABSTRACT

What is described is a connector for producing an electrically conductive connection between at least three terminals of battery cells. The connector comprises at least three fastening regions, in which in each case one terminal of a battery cell can be or is fastened, and at least two electrically conductive connecting regions, wherein each of the connecting regions is arranged between a pair of the fastening regions, connects said pair conductively and surrounds a sub-region, which has a cross section perpendicular to a connecting line connecting the pair of fastening regions, the cross-sectional area of said cross section being reduced such that, in the event of an increased current flow in the sub-region, fusing of the sub-region takes place.

The present invention relates to a connector for producing an electrically conductive connection between at least three terminals of battery cells and to a battery module having the connector according to the invention.

### PRIOR ART

A battery which comprises one or more galvanic battery cells acts as electrochemical energy store and energy transducer. During discharge of the battery or the respective battery cell, chemical energy stored in the battery is converted into electrical energy by electrochemical redox reaction. This electrical energy can be requested by a user, if required.

In particular in hybrid and electric vehicles, lithium-ion batteries or nickel-metal hydride batteries which comprise a large number of electrochemical cells connected in series are used in so-called battery packs. Generally, a battery management system including battery state identification is used for safety monitoring and for ensuring as long a life as possible.

Individual battery cells are in this case connected by means of connectors to form a battery, which batteries are in turn connected, by the arrangement of further connectors, to form the battery packs. Often, the battery cells are connected to one another in an electrical series circuit for the construction of entire systems, as a result of which the capacitance and the maximum available current remain constant, but the voltage of the system is markedly increased (up to several hundred volts). Interconnection of cells in parallel only takes place to a limited extent. In general, in this case only at most two battery cells are connected in parallel since, in the event of a short circuit in one of the two battery cells, the respective other battery cell is loaded with a long, high short-circuit current.

It has largely proven successful here for the battery cells and connectors to be connected to one another by screw connections. The cathode or the positive pole of the battery cell in this case consists of aluminum and the anode or the negative pole consists of copper. In order to produce an electrically conductive connection between the battery cells, a cell connector is used which is positioned on an outer thread at the terminal and is tightened by means of a nut.

Further alternative types of cell connection include the production of a material connection between the cell connector and the respective terminal, such as by welding or soldering, for example, or production of a form-fitting and/or force-fitting connection, for example using rivets.

Since, as mentioned above, one of the two battery cells is loaded with a long, high short-circuit current in the event of a short circuit, battery cells with a high energy content (so-called high-energy cells) are equipped with internal fuses which fuse in the event of loading for such a relatively long period of time and thus protect the battery cells and the system. However, this protection has the disadvantage that the battery cells necessarily need to be replaced. In the case of battery cells with a relatively low capacitance, such protection is not used at all.

### DISCLOSURE OF THE INVENTION

The invention provides a connector which is suitable for producing an electrically conductive connection between at least three terminals of battery cells. In this case, a terminal is understood to mean that part of a battery cell which is electrically conductively connected to an electrode in a battery cell body and protrudes with a section, the so-called battery pole, out of the battery cell body. The connector comprises at least three fastening regions, in which in each case one terminal of a battery cell can be fastened or is fastened. In addition, the connector comprises at least two electrically conductive connecting regions. Each of the connecting regions is arranged between a pair of the fastening regions and conductively connects the pair of fastening regions. In this case, the connecting regions and the fastening regions can merge with one another without any structural interface between the regions. For example, the connector can overall have an integral formation. In this case, various subdivisions in connecting regions and fastening regions are conceivable, and the profile of an interface between the regions is conceptual in nature.

Each of the connecting regions also comprises a subregion, which has a cross section perpendicular to a line connecting the pair of fastening regions having a cross-sectional area which is reduced in such a way that, in the event of an increased current flow in the subregion, fusing of the subregion takes place. More precisely, there is a section through the subregion perpendicular to the line connecting the pair of fastening regions with a reduced area. The connecting line is substantially parallel to a current direction in which a current flows between the fastening regions which are connected by the connecting region in the operational state when the connector is connected to the terminals of battery cells.

Electrical resistance in the subregion is increased by the reduced cross-sectional area, and, in the event of an increase in the current flow in the subregion, a temperature rise occurs which causes fusing of the subregion. Fusing of the subregion results in disconnection of the connector and therefore decoupling of a (defective) battery cell from the entire interconnected system. As a result, a parallel circuit comprising more than two battery cells is possible and, at the same time, protection is provided which can come to bear in the event of failure of one of the battery cells in the parallel connected system.

Therefore, provision is preferably made for the cross-sectional area to be reduced in such a way that fusing of the subregion takes place when the current flowing in the subregion exceeds a predetermined current threshold value, which suggests a malfunction of a battery cell connected to the connector.

This is particularly the case when there is a short circuit in the battery cell connected to the connector. It is thus possible to connect more than two battery cells in parallel with one another and at the same time to reduce the risk of thermal transfer in the event of a short circuit in one of the battery cells and the discharge associated therewith of the battery cells connected in parallel.

Typically, the connector has a strip-shaped formation and consists of a material with good electrical conductivity, in particular copper or aluminum.

A reduction in the cross-sectional area in the subregion is preferably achieved by virtue of the fact that the connecting region surrounding the subregion has at least one cutout or stamped-out portion in this subregion, for example a slot, a slit or a plurality of holes arranged in a row. This enables simplified production of the connector.

Preferably, the connector has precisely three fastening regions and precisely two connecting regions arranged therebetween.

A further aspect of the invention relates to a battery module, which comprises at least three battery cells, preferably lithium-ion battery cells, and at least one connector according to the invention, which connects terminals of the battery cells.

A further aspect of the invention relates to a battery, preferably a lithium-ion battery, which comprises a plurality of battery modules according to the invention which are connected in series or parallel.

A further aspect of the invention relates to a motor vehicle, in particular a motor vehicle which can be driven by an electric motor and which comprises at least one battery in accordance with the invention, wherein the battery is connected to a drive system of the motor vehicle.

### DRAWINGS

Exemplary embodiments of the invention will be explained in more detail with reference to the drawings and the description below. In the drawings:

FIG. 1 shows a connector in accordance with a first embodiment of the invention,

FIG. 2 shows a connector in accordance with a second embodiment of the invention, and

FIGS. 3 to 5 show equivalent circuit diagrams illustrating the mode of operation of the connector according to the invention.

### EMBODIMENTS OF THE INVENTION

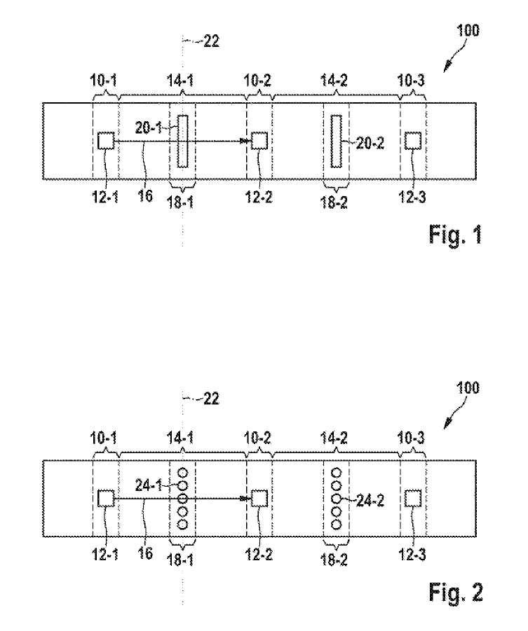

FIG. 1 shows a connector, denoted overall by 100, in accordance with a first embodiment of the invention. The connector 100 has a strip-shaped and integral formation and is shaped from a material with good electrical conductivity, such as copper or aluminum. The connector 100 comprises a first fastening region 10-1, a second fastening region 10-2 and a third fastening region 10-3. In each case one fastening point 12-1, 12-2, 12-3 is arranged in each of the three fastening regions 10-1, 10-2, 10-3, with terminals of identical polarity of three battery cells (not illustrated) being fastenable or fastened at said fastening points. In addition, the connector 100 comprises a first connection region 14-1 and a second connecting region 14-2, wherein each of the connecting regions 14-1, 14-2 is arranged in each case between a pair of fastening regions and conductively connects said fastening regions.

To be more precise, the first connecting region 14-1 is arranged between the first fastening region 10-1 and the second fastening region 10-2 and conductively connects said fastening regions. Correspondingly, the second connecting region 14-2 is arranged between the second fastening region 10-2 and the third fastening region 10-3 and conductively connects said fastening regions. A connecting line 16 can be imagined between the first fastening region 10-1 and the second fastening region 10-2, in particular between the first fastening point 12-1 and the second fastening point 12-2, with this connecting line substantially defining the direction of a current flow between the terminals of the battery cells.

Each of the connecting regions 14-1, 14-2 comprises subregions 18-1, 18-2, in which cutouts in the form of slots 20-1, 20-1 are provided. A section 22 through the subregion 18-1 which runs perpendicular to the connecting line 16 has, owing to the presence of the slots 20-1, a cross-sectional area which is reduced in comparison with the rest of the connecting region 14-1 outside the subregion 18-1. As a result, the electrical resistance in the subregion 18-1 is increased and there is a severe rise in temperature in the first subregion 18-1 when the current flowing in the first subregion 18-1 exceeds a predetermined current threshold value, which suggests a short circuit in a battery cell connected to the connector 100, for example a battery cell fastened at the first fastening point 12-1. By virtue of the severe rise in temperature in the subregion 18-1, fusing occurs in this subregion and thus severing of the connector 100 in the first subregion 18-1. As a result, disconnection of the battery cell fastened at the first fastening point 12-1 is achieved.

The slots 18-1, 18-2 are dimensioned such that, during normal current loading, the electrical resistance is not substantially increased in comparison with a completely formed connector. Only in the case of current loading which indicates significant problems in the battery cells connected in parallel, in particular a short circuit in a battery cell, is a temperature increase caused by the reduced area of the subregion 18-1 in the section 22 which is so high that fusing of the connector 100 takes place. After fusing of the first subregion 18-1, the connector 100 remains intact within the second and third fastening regions 10-2, 10-3 and the second connecting region 14-2, with the result that, by virtue of said regions, battery cells connected in parallel can continue to be used. The dimensioning of the cross-sectional area 22 determines the currents for which the connector 100 is safeguarded.

Repair to a battery comprising the connector is possible by virtue of the now defective connector 100 being removed and being replaced by a new one with simultaneous replacement of the defective battery cell with a new battery cell.

FIG. 2 shows the connector 100 according to the invention in a second embodiment of the invention, which differs from the embodiment illustrated in FIG. 1 in that, instead of two slots 18-1, 18-2, cutouts in the form of a plurality of holes are provided which are arranged in two rows 24-1, 24-2. The mode of operation of the connector 100 in accordance with the second embodiment of the invention substantially corresponds to that of the connector illustrated in FIG. 1.

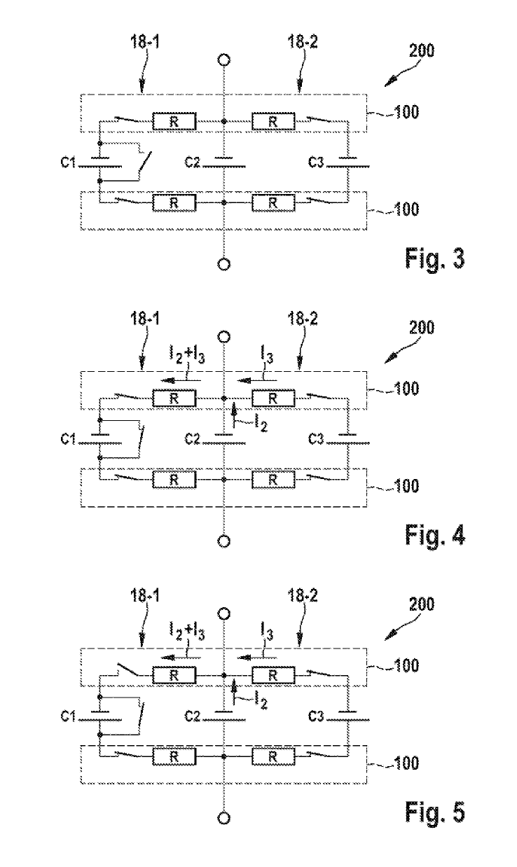

FIGS. 3 to 5 show, schematically, equivalent circuit diagrams illustrating the mode of operation of the connector 100 according to the invention. FIG. 3 shows a battery module 200, which comprises three battery cells C1, C2, C3, which are connected in parallel and are connected in each case by a connector 100 according to the invention at their positive and negative poles. The subregions 18-1, 18-2 are indicated, inter alia, in each case by a circuit symbol for a resistor R. One of the two connectors 100 according to the invention illustrated can be replaced by a connector known from the prior art without the mode of operation intended by the invention being impaired. A battery (not illustrated) comprises a plurality of battery modules 200 (illustrated in FIG. 3), which are connected in series or parallel.

FIG. 4 shows a schematic illustration of the effect of a short circuit in the battery cell C1 on the arrangement illustrated in FIG. 3. The total short-circuit current which flows into the first battery cell C1 comprises currents which are provided from the second battery cell C2 and the third battery cell C3. As a result, severe heating of the resistor R between the first battery cell C1 and the second battery cell C2 takes place, i.e. in the first subregion 18-1 of the connector 100. Said connector is heated in such a way that fusing of the subregion 18-1 and therefore electrical isolation of the first battery cell C1 arises, which is illustrated schematically in FIG. 5 by a circuit symbol for an open switch in the subregion 18-1.

1. A connector for producing an electrically conductive connection between at least three terminals of battery cells, the connector comprising:
at least three fastening regions each fastening region configured to enable one terminal of a battery cell to be fastened thereto, and
at least two electrically conductive connecting regions, each connecting region arranged between a pair of fastening regions, configured to conductively connect said pair of fastening regions, and including a subregion,
wherein each subregion has a cross section perpendicular to a connecting line connecting a pair of fastening regions, and
wherein each cross section has a reduced cross-sectional area configured to enable fusing of the subregion when a current flow in the subregion is increased.

2. The connector as claimed in claim 1, wherein the cross-sectional area is reduced to enable fusing of the subregion when the current flowing in the subregion exceeds a predetermined current threshold value, to suggest a malfunction of a battery cell connected to the connector.

3. The connector as claimed in claim 1, wherein the connector has a strip-shaped formation.

4. The connector as claimed in claim 1, wherein at least one connecting region of the at least two connecting regions has at least one cutout or stamped-out portion in the subregion.

5. The connector as claimed in claim 4, wherein the at least one connecting region has a slot or a slit in the subregion.

6. The connector as claimed in claim 4, wherein the at least one connecting region has a multiplicity of holes arranged in a row in the subregion.

7. The connector as claimed in claim 2, wherein the connector has precisely three fastening regions and precisely two connecting regions.

8. The connector as claimed in claim 1, wherein the connector is shaped from a material with good electrical conductivity.

9. A battery module, comprising:
at least three battery cells; and
at least one connector, including:
at least three fastening regions, each fastening region configured to enable one terminal of a battery cell to be fastened thereto, and
at least two electrically conductive connecting regions, each connecting region arranged between a pair of fastening regions, configured to conductively connect said pair of fastening regions, and including a subregion,
wherein each subregion has a cross section perpendicular to a connecting line connecting a pair of fastening regions,
wherein each cross section has a reduced cross-sectional area configured to enable fusing of the subregion when a current flow in the subregion is increased, and
wherein the at least one connector is configured to connect terminals of the at least three battery cells.

10. A battery, comprising:
a plurality of battery modules, including:
at least three battery cells; and
at least one connector, including:
at least three fastening regions, each fastening region configured to enable one terminal of a battery cell to be fastened thereto; and
at least two electrically conductive connecting regions, each connecting region arranged between a pair of fastening regions, configured to conductively connect said pair of fastening regions, and including a subregion,
wherein each subregion has a cross section perpendicular to a connecting line connecting a pair of fastening regions,
wherein each cross section has a reduced cross-sectional area configured to enable fusing of the subregion when a current flow in the subregion is increased,
wherein the at least one connector is configured to connect terminals of the at least three battery cells, and
wherein the plurality of battery modules are connected in series or parallel.

11. The battery as claimed in claim 10, wherein the battery is configured to connect to a drive system of a motor vehicle.

12. The connector as claimed in claim 2, wherein the malfunction of the battery cell is a short circuit in the battery cell.

13. The connector as claimed in claim 8, wherein the material is one of copper and aluminum.

14. The battery as claimed in claim 10, wherein the battery is one of a lithium-ion battery and a nickel-metal hydride battery.

15. The battery as claimed in claim 11, wherein the motor vehicle is configured to be driven by an electric motor.

16. The battery as claimed in claim 11, wherein the drive system is configured to connect to more than one battery.
